(19) United States
(12) Patent Application Publication
(10) Pub. No.: US 2026/0249305 A1
(43) Pub. Date: Aug. 27, 2026

(54) Apparatus and Method for Connecting Magnetic Tubes to Fluid Magnetic Separators

(71) Applicant: Industrial Magnetics, Inc., Boyne City, MI (US)

(72) Inventor: Cameron Pond, Cassopolis, MI (US)

(73) Assignee: Industrial Magnetics, Inc., Boyne City, MI (US)

(21) Appl. No.: 19/060,230

(22) Filed: Feb. 21, 2025

(51) Int. Cl. B03C 1/28

(52) U.S. Cl. CPC B03C 1/284; B03C 2201/18; B03C 2201/28

(57) ABSTRACT

A magnetic separator for removing magnetic contaminants from process fluids having a housing with an inlet and outlet for communicating the process fluids through the housing. A removable structure is removably connected to and encloses the housing, wherein the removable structure has at least one aperture and at least one dimple formed about the circumference of each of the at least one aperture in the removable structure. At least one magnetic tube each having an open end received by one of the at least one aperture in the removable structure and a closed end disposed within the interior of the housing. The at least one dimple is seam welded to the at least one magnetic tube to further support the connection between the at least one magnetic tube and the removable structure. The removable structure may comprise an upper lid or drawer in the housing of the magnetic separator.

### FIELD OF THE INVENTION

The present disclosure generally relates to single and multi-tube magnetic separators designed to remove magnetic contaminants from a wide range of industrial and agricultural materials, including process fluids, powders, bulk solids, grains, oilseeds, pulses, and processed products such as flours, meals, and feed materials. More particularly, the present disclosure pertains to magnetic separators incorporating one or more tubes containing permanent magnets, which extend from a removable lid(s), drawer(s), or cover(s) into a processing chamber. The processing chamber may take the form of a housing, enclosure, conduit, trench, or other containment structure and is configured with an inlet and an outlet to facilitate the controlled movement of process materials—including, but not limited to, fluids, powders, bulk solids, grains such as wheat, corn, oats, barley, and rice; oilseeds such as soybeans, canola, sunflower seeds, and flaxseeds; pulses such as lentils, chickpeas, beans, and peas; and processed products such as flours, meals, and feed materials—through or across one or more magnetic tubes, thereby capturing and removing ferrous contaminants. The present disclosure further relates to an apparatus and method for securely and efficiently connecting the magnetic tube(s) to the removable lid(s), drawer(s), or cover(s), ensuring structural integrity, operational reliability, and ease of maintenance.

### BACKGROUND

Process materials such as fluids, powders, and bulk solids are widely used across various industries, including food processing, animal feed production, grain handling, plastics manufacturing, pharmaceuticals, and petrochemicals. In these industries, metal contaminants are routinely introduced into process materials due to mechanical wear, equipment degradation, or unintended material intrusion. Magnetic separation and filtration systems are often installed to capture and remove ferrous contaminants, thereby improving product purity and protecting sensitive equipment from damage. These magnetic filtration systems are strategically placed before pumps, screens, mills, and other processing equipment to prevent mechanical failures, reduce maintenance downtime, and enhance overall operational efficiency.

Magnetic filtration systems often incorporate magnetic separators that employ permanent magnetic tubes positioned within a processing chamber, such as a housing, conduit, or containment structure. The chamber is provided with an inlet and outlet to direct the flow of process materials through or across the magnetic tube(s), allowing ferrous contaminants to be captured. In prior designs, magnetic tubes are affixed to the underside of a lid or the inside surface of a drawer that is removably connected to the housing. Conventionally, the tubes are welded directly to these structures, forming a rigid connection.

From time to time, the metal contaminants that gather on the magnetic tubes must be removed from the magnetic tubes to ensure that the metal contaminants are effectively and efficiently drawn to the magnetic tubes and are not transported or re-comingled into the process fluids. To remove the metal contaminants from the magnetic tubes, the lid or drawer and the magnetic tubes may be removed from the housing so that the metal contaminants may be wiped from the magnetic tubes. When this occurs, certain random forces may be applied to the magnetic tubes during the cleaning of the magnetic tubes as well as during the disassembly, reassembly, and handling of the lid or drawer and the magnetic tubes to the housing. Due to the cantilevered positioning of the magnetic tubes relative to the lid or drawer of the housing and the sole connection of the end of the magnetic tubes to the underside of the lid or inside surface of the drawer, such random forces have been known to dislodge the magnetic tubes from the underside of the lid or the inside surface of the drawer by cracking or breaking the welded connection between the magnetic tubes and the underside of the lid or the inside surface of the drawer. Such dislodgement of the magnetic tubes requires that the magnetic tubes be rewelded, reconnected, or replaced thereby requiring the shutting down of the magnetic filtration system for maintenance. This creates inefficiencies that are undesirable in an industrial environment.

It would be desirable to provide a more robust connection between the magnetic tubes and the underside of the lid or the inside surface of the drawer of the housing of a magnetic separator that eliminates or reduces the risks of the magnetic tubes being dislodged from the underside of the lid or the inside surface of the drawer of the housing when cleaning the metallic contaminants from the magnetic tubes and/or handling the magnetic tubes during the assembly and disassembly of the magnetic separator to reduce the amount of maintenance required of the magnetic separator thereby increasing the efficiency associated with operating the magnetic filtration system.

### SUMMARY OF THE DISCLOSURE

The present disclosure provides a magnetic separator for removing magnetic contaminants from process fluids wherein the magnetic separator has a housing with an inlet and an outlet for communicating the process fluids through the housing. A removable structure may be removably connected to and enclose the housing, wherein the removable structure has at least one aperture and a at least one dimple wherein the at least one dimple is formed about the circumference of each of the at least one aperture in the removable structure. At least one magnetic tube each has one end received by one of the at least one aperture in the removable structure and a second, opposite end disposed within the interior of the housing. The at least one dimple is connected to the at least one magnetic tube to further support the connection between the at least one magnetic tube and the removable structure.

The at least one magnetic tube is seam welded to the at least one dimple on the removable structure, wherein the removable structure provides a main plate having the at least one aperture extending therethrough. A radius plate is connected to the main plate and has the at least one aperture extending therethrough wherein the at least one aperture in the radius plate is coaxially aligned with the at least one aperture in the main plate. The radius plate has an inner surface facing the interior of the housing, wherein the at least one dimple is formed on the inner surface of the radius plate and may have a frustoconical configuration extending away from the inner surface of the radius plate. The removable structure also provides a cover plate connected to the main plate for covering the at least one aperture on one side of the main plate.

The magnetic separator for removing magnetic contaminants from process fluids may also have a housing with an inlet and an outlet for communicating the process fluids through the housing. A removable structure may be removably connected to and enclose the housing, and the removable structure may include a main plate and a radius plate. The main plate may have a plurality of apertures extending therethrough for receiving a plurality of magnetic tubes wherein one of the plurality of magnetic tubes extends through each of the plurality of apertures and wherein the plurality of magnetic tubes are connected to the main plate. The radius plate may be connected to the main plate and have a plurality of apertures extending therethrough and coaxially aligned with the plurality of apertures in the main plate for receiving one of the plurality of magnetic tubes in each of the plurality of apertures in the radius plate. A plurality of dimples may be formed about the circumference of each of the plurality of apertures in the radius plate. The plurality of magnetic tubes may be welded to the plurality of dimples to connect the plurality of magnetic tubes to the radius plate and further support the connection between the plurality of magnetic tubes and the removable structure, wherein the plurality of magnetic tubes are disposed within the housing for attracting the magnetic contaminants from the process fluids.

The plurality of dimples each have a frustoconical configuration extending away from the radius plate toward the interior of the housing and along a longitudinal axis of the plurality of magnetic tubes. The plurality of magnetic tubes may be seam welded to the plurality of dimples of the radius plate and seam welded to the main plate.

The removable structure of the magnetic separator may comprise an upper lid of the housing or at least one least drawer slidably connected to the housing.

The main plate of the magnetic separator may have a plurality of apertures extending through the main plate. A cover plate may be connected to the main plate on the opposite side of the main plate as the radius plate. The cover plate covers the plurality of apertures on one side of the main plate wherein one end of the plurality of magnetic tubes may be adjacent to the cover plate.

The plurality of apertures in the main plate, the plurality of apertures in the radius plate, and the plurality of magnetic tubes may be spaced substantially equidistant from one another. A plurality of permanent magnets and spacers may be disposed within the plurality of magnetic tubes. The plurality of magnetic tubes each have an open end connected to the main plate and a closed end disposed within the interior of the housing.

The present disclosure also discloses a method of fabricating a magnetic separator for separating magnetic contaminants from process fluids. The steps of the method include providing a housing having an inlet and an outlet for communicating process fluids through the housing; providing a removable structure having a main plate and a radius plate wherein the removable structure may be removably connected to the housing for enclosing the housing; forming at least one aperture in the main plate; forming at least one aperture and at least one dimple in the radius plate wherein the at least one dimple is formed about a circumference of the at least one aperture in the radius plate; connecting the main plate to the radius plate such that the at least one aperture in the main plate is coaxially aligned with the at least one aperture in the radius plate; inserting at least one magnetic tube through the at least one aperture in the main plate and through the at least one aperture in the radius plate; connecting the at least one magnetic tube to the main plate; and connecting the at least one magnetic tube to the at least one dimple on the radius plate.

The step of forming at least one aperture and at least one dimple in the radius plate may include providing the at least one dimple with a frustoconical configuration that extends around the circumference of the at least one aperture in the radius plate and extends away from the radius plate toward the interior of the housing along a longitudinal axis of the at least one magnetic tube. The steps further include seam welding the at least one magnetic tube to the main plate and to the at least one dimple on the radius plate.

The steps may also include extending the at least one aperture through the main plate and connecting a cover plate to the main plate on the opposite side of the main plate as the radius plate for covering the at least one aperture on one side of the main plate and adjacently aligning the cover plate with one end of the at least one magnetic tube.

The step of providing a removable structure further comprises the steps of providing at least one drawer that slidably engages the housing. The step of providing a removable structure may further comprise providing an upper lid for the housing.

The steps further include seam welding the at least one magnetic tube to the main plate and to the at least one dimple on the radius plate; inserting a plurality of permanent magnets and spacers into the at least one magnetic tube; and providing the at least one magnetic tube with an open end connected to the main plate for receiving a plurality of permanent magnets and spacers and a closed end disposed within the interior of the housing.

### BRIEF DESCRIPTION OF THE DRAWINGS

The present disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a perspective view of a magnetic separator of the present disclosure having an upper lid as a removable structure;

FIG. 2 is a perspective view of the upper lid and magnetic tubes of the magnetic separator of the present disclosure;

FIG. 3 is a left side plan view of the upper lid and magnetic tubes of the magnetic separator of the present disclosure;

FIG. 4 is front plan view of the upper lid and magnetic tubes of the magnetic separator of the present disclosure;

FIG. 5 is a right side plan view of the upper lid and magnetic tubes of the magnetic separator of the present disclosure;

FIG. 6 is a bottom plan of the upper lid and magnetic tubes of the magnetic separator of the present disclosure;

FIG. 7 is a front plan view of a radius plate of the magnetic separator of the present disclosure;

FIG. 8 is a side plan view of the radius plate of the magnetic separator of the present disclosure;

FIG. 9 is a front plan view of the main plate of the magnetic separator of the present disclosure;

FIG. 10 is a side plan view of the main plate of the magnetic separator of the present disclosure;

FIG. 11 is a front plan view of the magnetic tubes, the radius plate, and the main plate of the magnetic separator of the present disclosure;

FIG. 12 is a side plan view of the magnetic tubes, the radius plate, and the main plate of the magnetic separator of the present disclosure;

FIG. 13 is a sectional view of the upper lid and magnetic tubes of the magnetic separator of the present disclosure;

FIG. 14 is a top plan view of the magnetic separator of the present disclosure having drawers as the removable structure;

FIG. 15 is a front plan view of the magnetic separator of the present disclosure having drawers as the removable structure;

FIG. 16 is a side plan view of the magnetic separate of the present disclosure having drawers as the removable structure;

FIG. 17 is a perspective view of a drawer of the magnetic separator of the present invention; and

FIG. 18 is a perspective view of the radius plate of the magnetic separator of the present invention.

### DETAILED DESCRIPTION

The present disclosure relates to a magnetic filtration system (not shown) having a pneumatically, manually, mechanically, or hydraulically operated, single or multi-tube magnetic separator 12 for separating and removing magnetic or ferrous contaminants (not shown) from a wide range of industrial and agricultural process fluids (not shown). The magnetic separator 12 may incorporate one or more magnetic tubes containing permanent magnets which extend from a removable structure into a processing chamber. In a nonlimiting disclosure, the removable structure may comprise one or more lids, drawers, or covers. The processing chamber may take the form of a housing, enclosure, conduit, trench, or other containment structure and is configured with an inlet and outlet to facilitate the controlled movement of the process fluids through or across the magnetic tube(s) allowing ferrous containments to be captured by the magnetic tube(s). The magnetic separator 12 may be equipped in magnetic filtration systems employed in numerous industries, including but not limited to, the food, feed, and grain industry, the plastics industry, the pharmaceutical industry, and the Petrochem industry. The process fluids themselves can be wide-ranging and may include various process fluids, powders, bulk solids, including food ingredients, animal feed, grains, seeds, pulses, processed products, raw materials for plastics, recycled plastics, raw materials and chemicals for pharmaceuticals, and oil, gas, and chemicals used in petrochemical operations.

The magnetic separator 12 is of the in-line type in relation to fluid-flow traveling through the magnetic separator 12 and depending on its size, and in a nonlimiting disclosure, the magnetic separator 12 can handle various fluid flow rates with a line pressure extending up to 150 psi. The magnetic separator 12 may be a part of a larger magnetic filtration system in which multiple individual magnetic separators 12 may be arranged in parallel to one another to receive and feed process fluids from a common manifold. The magnetic contaminants captured by the magnetic separator 12 are generally ferrous materials and may include particles, dust, slurry, or other similar contaminants, depending on the application and process. In addition, the magnetic contaminants subject to removal may be initially non-metallic particles that may be subsequently induced to associate with magnetic particles, making them susceptible to a magnetic field. Thus, the term magnetic contaminants is used expansively herein and is intended to embrace all of these possibilities. Furthermore, the size of the magnetic contaminants subject to capture may vary. The separation and removal of the magnetic contaminants are carried out by the magnetic separator 12 without harming the process fluids containing the magnetic contaminants. The magnetic separator 12 can have varied designs, constructions, and components in different embodiments, dictated at least in part by the particular application and contaminants.

Furthermore, unless otherwise specified, the terms radially, axially, circumferentially, vertically, horizontally, rectangular, top, and bottom, and their grammatical variations refer to directions with respect to the general shape of the magnetic separator 12 and its components as illustrated in the figures.

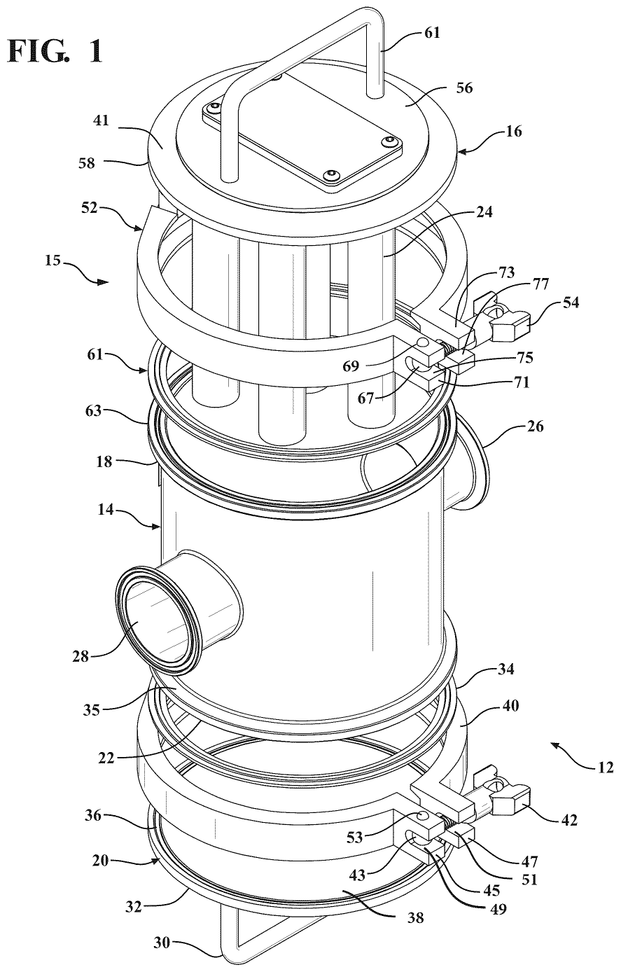

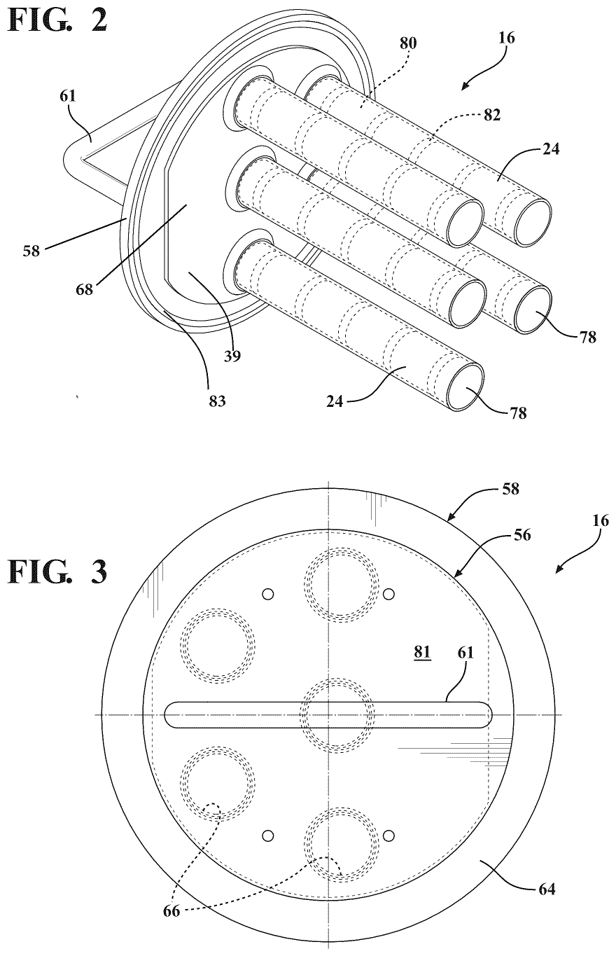

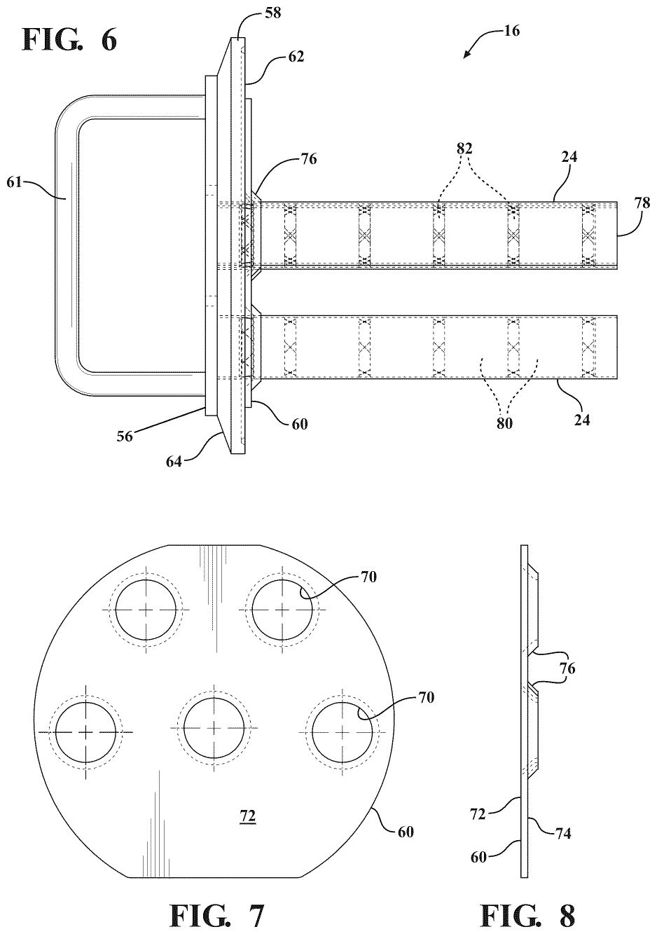

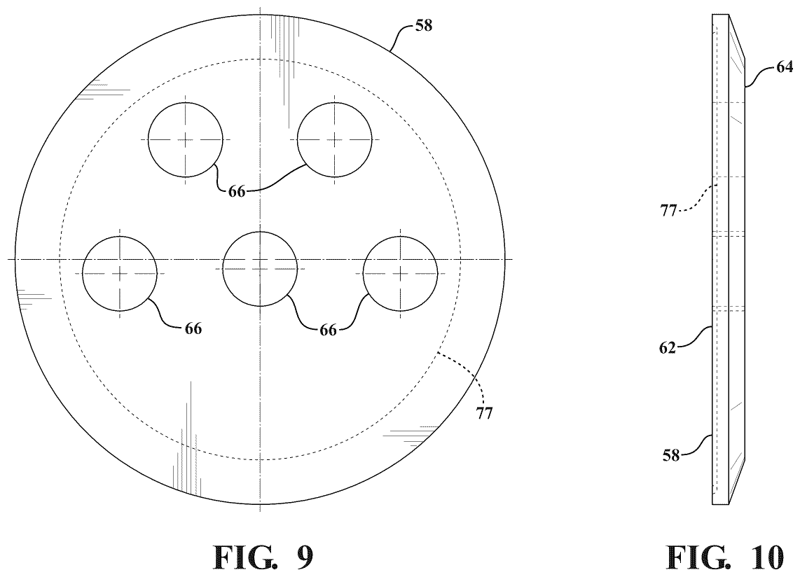

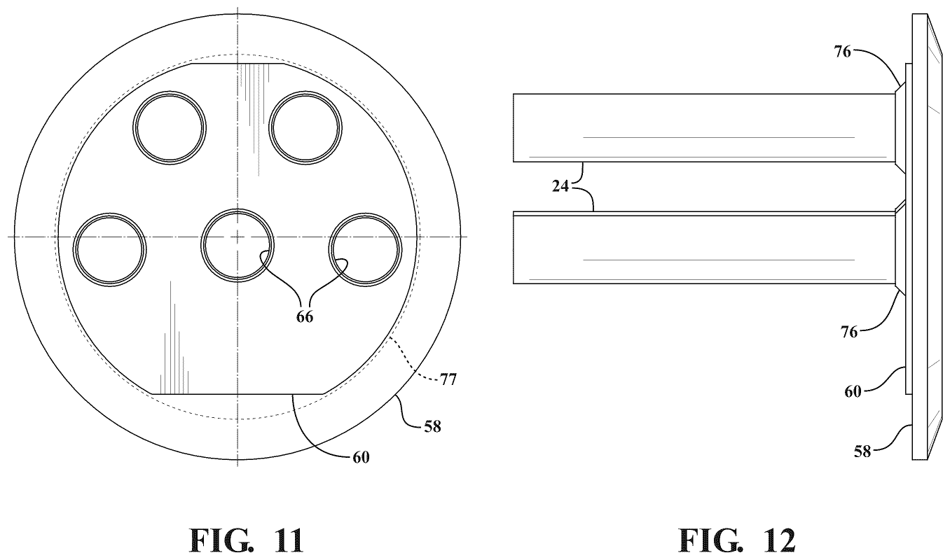

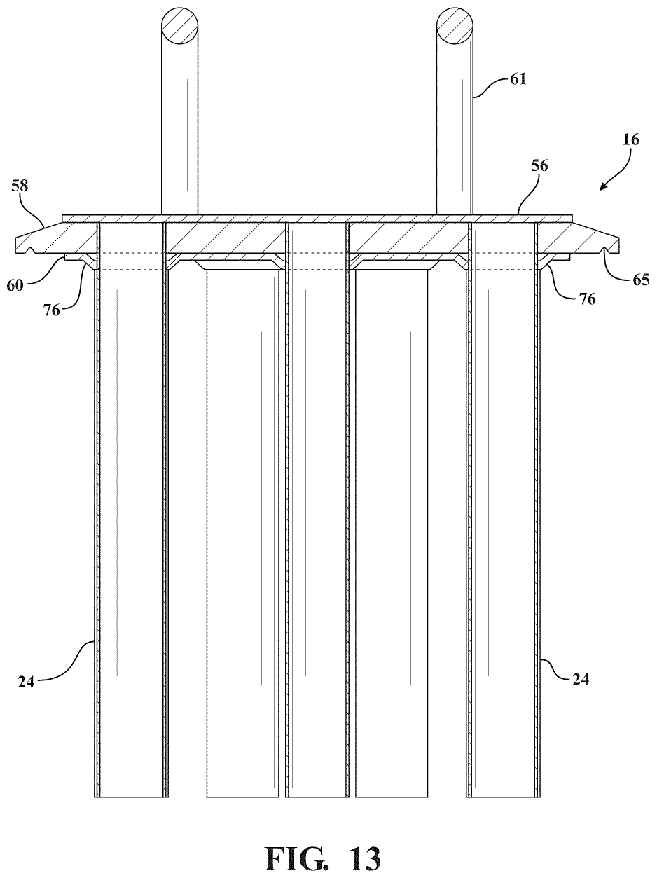

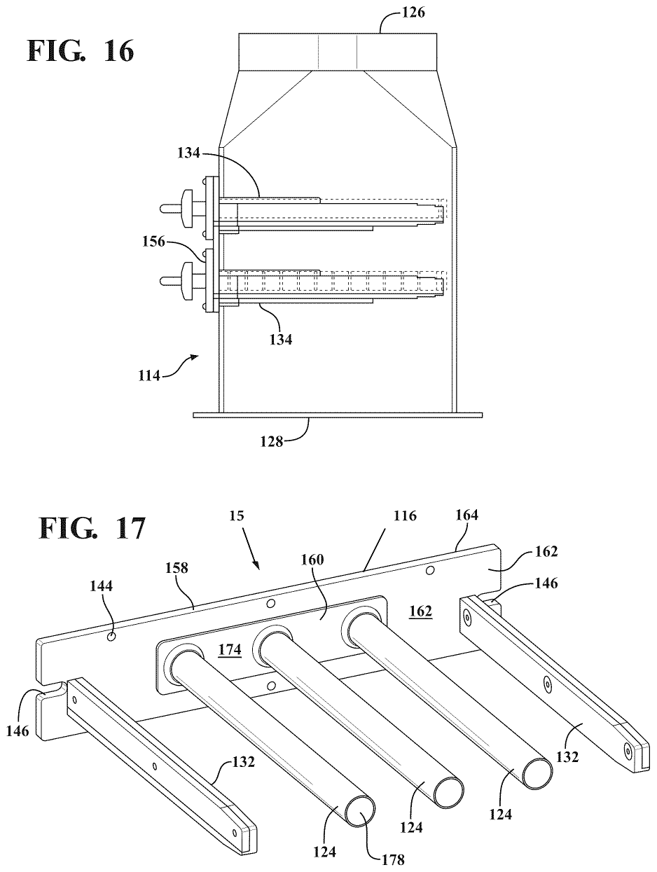

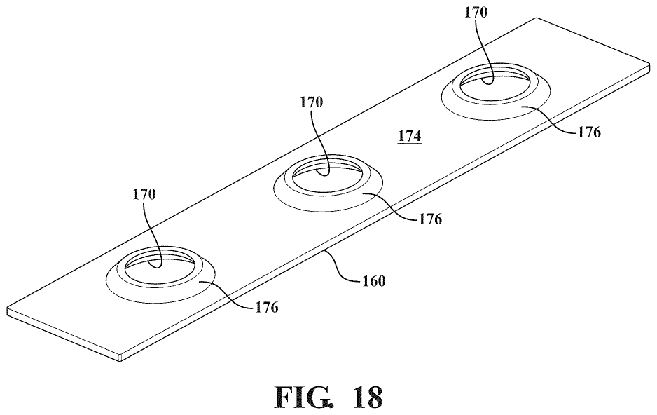

As seen in FIG. 1-18, the magnetic filtration system may include the magnetic separator 12 which is pneumatically or gravity operated and actuated and, in general, includes a hollow housing 14 having a removable structure or portion 15 that is removably connected to the housing 14 and encloses the housing 14 when the removable portion 15 is connected to the housing 14. At least one magnetic tube 24, which shall be referred to as magnetic tubes 24, is connected to the removable portion 15 and extends into and is disposed within a processing chamber of the housing 14 when the removable portion is connected to the housing. An inlet 26 and an outlet 28 are in communication with the interior of the housing 14, wherein the inlet 26 and the outlet 28 communicate process fluids in and out of the processing chamber and through the housing 14 of the magnetic separator 12. As the process fluids pass through the processing chamber in the interior of the housing 14 and across the at least one magnetic tube 24, magnetic contaminants are attracted to the magnetic tubes 24 thereby separating the magnetic contaminants from the process fluids. When necessary, the removable portion 15 may be removed from the housing 14 to clean the magnetic contaminants from the magnetic tubes 24 and then returned to the housing 14 once the magnetic contaminants have been removed.

In one embodiment of the present disclosure as seen in FIGS. 1-13, the magnetic separator 12 may take on the form of what is commonly referred to in the industry as a multi tube T-trap magnetic separator which is commonly used to remove magnetic contaminants from process fluids such as liquids, purees, non-fragile solids, and crushed or viscous products. The housing 14 of the magnetic separator may have a substantially cylindrical, hollow configuration wherein the removable portion 15 comprises a removable upper lid 16 that encloses a top end 18 of the housing 14. The magnetic tubes 24 are connected to the underside of the upper lid 16 and extends longitudinally downward or substantially vertical from the underside of the upper lid 16 and is disposed within the housing 14 when the upper lid 16 is connected to the housing 14. A removable lower lid 20 may enclose a bottom end 22 of the housing 14; however, the lower lid 20 does not have any magnetic tubes 24 connected thereto. The inlet 26 and the outlet 28 are in communication with the interior of the housing 14, wherein the inlet 26 and the outlet 28 communicate process fluids through the housing 14 of the magnetic separator 12 for separating magnetic contaminants from the process fluids.

To allow the process fluids to pass by the magnetic tubes 24 and through the magnetic separator 12, the housing 14 of the magnetic separator 12 has a substantially cylindrical, hollow configuration having the inlet 26 and the outlet 28 integrally formed with the housing 14 and extending away from the housing 14 in opposite directions and from opposite sides of the exterior of the housing 14. The inlet 26 and the outlet 28 have similar substantially cylindrical, hollow configurations wherein the inlet 26 allows process fluids to pass into the housing 14, and the outlet 28 allows process fluids to travel out of the housing 14. The inlet 26 and the outlet 28 have longitudinal axes that are substantially perpendicular to a longitudinal axis of the housing 14. The free ends of the inlet 26 and the outlet 28 extend away from the housing 14 and may be sealingly connected to tubing or piping (not shown) that transfer the process fluids to and from the magnetic separator 12. In a nonlimiting disclosure, the housing 14, inlet 26, and outlet 28 may be fabricated from a light weight, high strength material such as steel or aluminum; however, other light weight, high strength materials may be used depending on the chemical composition or toxicity of the process fluids.

To drain any contaminants and process fluids from the housing 14 of the magnetic separator 12, the lower lid 20 of the housing 14 is removably connected to the bottom end 22 of the housing 14 in a sealed manner. The lower lid 20 has a substantially cylindrical, plate-like configuration wherein a substantially U-shaped handle 30 is connected to an outer surface 32 of the lower lid 20, wherein the outer surface 32 of the lower lid 20 faces away from the interior of the housing 14. The handle 30 may be utilized to secure and handle the lower lid 20 when assembling and disassembling the lower lid 20 to the housing 14. In a nonlimiting disclosure, the lower lid 20 and the handle 30 may be fabricated from a light weight, high strength material, such as steel or aluminum. The lower lid 20 is sealingly connected to the bottom end 22 of the housing 12 using a flexible O-ring 34 which is seated in a recess formed in a circumferential lip 35 extending radially outward from the bottom end 22 of the housing 14. A seal ring 36 may be seated within a circumferential recess formed on an inner surface 38 of the bottom lid 20, wherein the inner surface 38 of the bottom lid 20 faces the interior of the housing 14. A substantially cylindrical, C-shaped clamp 40 may be utilized to removably connect the lower lid 20 to the housing 14, wherein the C-shaped clamp 40 may have a threaded wing nut 42 that is threaded onto a cylindrical threaded rod 43 that extends through two end portions 45, 47 of the C-shaped clamp 40. The two end portions 45, 47 extend radially outward from the circumferential ends of the C-shaped clamp 40 in a juxtaposed position wherein the end portions 45, 47 have C-shaped slots 49, 51 that extend through the end portions 45, 47 and open away from the C-shaped clamp 40. One end of the threaded rod 43 is pivotally connected to one end portion 45 of the C-shaped clamp by a pivot pin 53 allowing the threaded rod 43 to pivot in and out of the C-shaped slots 49, 51 provided in the end portions 45, 47 of the C-shaped clamp 40. When the threaded rod 43 is disposed within the C-shaped slots 49, 51 in the end portions 45, 47 of the C-shaped clamp 40, the wing nut 42 may be threaded along the threaded rod 43 to tighten or loosen the C-shaped clamp 40 against the lower lid 20 and the housing 14 by reducing or enlarging, respectively, the diameter of the C-shaped clamp 40.

To secure the lower lid 20 to the bottom end 22 of the housing 14 in a sealed manner, the C-shaped clamp 40 circumferentially engages the lower lid 20 and the bottom end 22 of the housing 14. The C-shaped clamp 40 has a lip that extends radially inward on both the upper and lower end of the C-shaped clamp 40, wherein the lip on the upper end of the C-shaped clamp 40 extends over the lip 35 on the bottom end 22 of the housing 14, and the lip on the lower end of the C-shaped clamp 40 extends over the outer perimeter of the lower lid 20. This allows the bottom end 22 of the housing 14 to sealingly engage the lower lid 20 with the O-ring 34 on the bottom end 22 of the housing 14 and the seal ring 36 on the lower lid 20. The wing nut 42 may be rotated clockwise to circumferentially tighten the C-shaped clamp 40 against the lower lid 20 and the bottom end 22 of the housing 14 to secure the lower lid 20 to the bottom end 22 of the housing 14 in a sealed manner so that the process fluids my pass through the housing 14 when the magnetic separator 12 is in operation without the process fluids leaking from the housing 14. To remove the lower lid 20 from the housing 14 so that contaminants and process fluids can be removed from the housing 14 when the magnetic separator 12 is not in operation, the wing nut 42 may be rotated counter-clockwise to circumferentially enlarge the C-shaped clamp 40 thereby loosening the connection between the lower lid 20 and the bottom end 22 of the housing 14 so that the lower lid 20 may be removed from the housing 14 thereby allowing containments and process fluids in the housing 14 to fall and drain from the bottom end 22 of the housing 14. If necessary, the threaded rod 43 may be pivoted outward away from the C-shaped slots 49, 51 in the end portions 45, 47 of the C-shaped clamp to allow the C-shaped clamp 40 to be opened to a greater degree. Once the lower lid 20 is removed, access to the inside of housing 14 may be garnered to clean any contaminants from the inside walls of the housing 14.

To allow for the removal of the upper lid 16 from the top end 18 of the housing 14 for removing magnetic contaminants from the magnetic tubes 24 when the magnetic separator 12 is not in operation, the upper lid 16 is removably connected to the top end 18 of the housing 14 in a similar manner as to how the lower lid 20 is removably attached to the bottom end 22 of the housing 14. As seen in FIGS. 1-6, the upper lid 16 will be generally described as having a substantially cylindrical, plate-like configuration having an outer surface 56 that faces outside or away from the interior of the housing 14 and an inner surface 58 that faces toward the interior of the housing 14. A U-shaped handle 61 is connected to the outer surface 56 of the upper lid 16 for handling and lifting the upper lid 16 during assembly and disassembly of the magnetic separator 12. To removably attach the upper lid 16 to the top end 18 of the housing 14 in a sealed manner, a flexible O-ring 61 is seated within a recess formed in a lip 63 extending radially outward from the top end 18 of the housing 14, and a flexible seal 65 is seated within a circumferential recess formed in an inside surface 50 of the upper lid 16. A second C-shaped clamp 52, similar to the C-shaped clamp 40 on the bottom 22 of the housing 14, has a wing nut 54 that is threadedly received by a threaded rod 67 which is pivotally connected at one end of the threaded rod 67 by a pivot pin 69 in one 71 of two end portions 71, 73 of the C-shaped clamp 52 that extend radially outward in a juxtaposed position from the ends of the circumferential portion of the C-shaped clamp 52. Each of the two end portions 71, 73 of the C-shaped clamp 52 have C-shaped slots 75, 77 that extend through the end portions 71, 73 and open away from the circumferential portion of the C-shaped clamp 52. The threaded rod 67 is disposed in the C-shaped slots 73, 75 with a free end of the threaded rod 67 extending beyond one end portion 73 of the C-shaped clamp 52 to threadedly engage the wing nut 54. The wing nut 54 may be threadedly rotated on the threaded rod 67 to tighten or loosen the upper lid 16 from the top 18 of the housing 14 by making the diameter of the C-shaped clamp 53 smaller or larger. If necessary, the threaded rod 67 can be pivoted outward away from the C-shaped slots 75, 77 in the end portions 71, 73 of the C-shaped clamp 53 so that the C-shaped clamp 53 may be opened to a larger degree.

To secure the upper lid 16 to the top end 18 of the housing in a sealed manner, the C-shaped clamp 53 provides a lip extending radially inward at the top and the bottom of the C-shaped clamp 52 wherein the lip at the bottom of the C-shaped clamp 52 extends over the lip 63 at the top end 18 of the housing 14, and the lip at the top of the C-shaped clamp 52 engages the outer circumference of the upper lid 16. Once the C-shaped clamp is positioned around the circumference of both the upper lid 16 and the top end 18 of the housing 14, the wing nut 54 may be rotated clockwise and threaded onto the threaded rod provided in the end portions 71, 73 of the C-shaped clamp 52 to reduce the diameter of the C-shaped clamp 52 thereby securing the upper lid 16 to the top end 18 of the housing 14 in a secured and sealed manner when the magnetic separator 12 is in operation. To remove the upper lid 16 and clean the magnetic contaminants form the magnetic tubes 24 when the magnetic separator 12 is not in operation, the wing nut 54 on the C-shaped clamp 52 is rotated in a counterclockwise direction thereby enlarging the diameter of the C-shaped clamp 52 and allowing the upper lid 16 to be removed from the top end 18 of the housing 14. Once the upper lid 16 and the magnetic tubes 24 are removed from the housing 14, the magnetic contaminants may be wiped clean from the outer surfaces of the magnetic tubes 24.

To secure the magnetic tubes 24 to the upper lid 16 of the magnetic separator 12, the upper lid 16 includes a cover plate 56, a main plate 58, and a radius plate 60, as seen in FIGS. 1-13. In a nonlimiting disclosure, the cover plate 56, the main plate 58, and the radius plate 60 may all be fabricated from a light weight, high-strength metallic material, such as steel or aluminum. The main plate 58 has a substantially circular, disc shaped configuration having an inner surface 59 that faces toward the interior of the housing 14 when the upper lid 16 is secured to the housing 14, and an outer surface 64, opposite the inner surface 62, that faces toward the exterior of the housing 14. The main plate 58 has a substantially constant diameter extending from the inner surface 62 to approximately midway to the outer surface 64, wherein the outer diameter of the main plate 58 tapers radially inward toward the outer surface 64 of the main plate 58. At least one aperture 66, hereby referenced as apertures 66, extends through the main plate 58 from the inner surface 62 to the outer surface 64 of the main plate 58, and the number of apertures 66 corresponds to the number of magnetic tubes 24 in the magnetic separator 12. In a nonlimiting disclosure, there may be a plurality of apertures 66 or five apertures 66 in the main plate 58 corresponding to a plurality or five magnetic tubes 24, but a different number of apertures 66 and magnetic tubes 24 may be used based on the size and configuration of the magnetic separator 12. The five apertures 66 in the main plate 58 are spaced substantially equidistant from one another with one aperture 66 located close to the center of the main plate 58, and the other four apertures 66 having their centers located at a substantially equal radial distance from the center of the main plate 58 along close to one half of the main plate 58. The magnetic tubes 24 are strategically located with respect to the inlet 26 and the outlet 28 of the housing 14 to allow for the magnetic contaminants to gather on the magnetic tubes 24. For instance, the magnetic tubes 24 are positioned on the side of the main plate 58 away from the inlet 26 and close to the outlet 28 to allow the process fluids to slow before contacting the magnetic tubes 24 so that the magnetic contaminants have the greatest chance of being attracted to and caught by the magnetic tubes 24.

To cover the apertures 66 on the outer surface 64 of the main plate 58, the cover plate 56 has a substantially circular, disc shaped configuration having an outer diameter that is substantially the same or similar to the outer diameter of the outer surface 64 of the main plate 58. The cover plate 56 has an inner surface 79 that overlies the outer surface 64 of the main plate 58 and is connected to the main plate 58 by seam welding the circumference of the cover plate 56 to the circumference of the outer surface 64 of the main plate 58. The cover plate 56 covers the apertures 66 exposed on the outer surface 64 of the main plate 58. The magnetic tubes 24 extend through the apertures 66 in the main plate 58 and may abut or come close to contacting the inner surface 79 of the cover plate 56 thereby providing further support to the magnetic tubes 24. The magnetic tubes 24 are seam welded to the main plate 58 along the area of the main plate 58 that defines the apertures 66 where the magnetic tubes 24 pass through the apertures 66 in the main plate 58. The ends of the U-shaped handle 61 are seam welded to an outside surface 81 of the cover plate 56.

To further support the attachment of the magnetic tubes 24 to the upper lid 16, the radius plate 60 has a substantially circular, disc shaped configuration having an outer diameter that is smaller than the outer diameter of the inner surface 62 of the main plate 58. The radius plate 60 has at least one aperture 70, hereby referred to as apertures 70, that extends through the radius plate 60 and are coaxially aligned in position and number with the apertures 66 provided in the main plate 58. The radius plate 60 has a substantially flat outer surface 72 that is seated within a substantially circular recess 77 provided on the inner surface 62 of the main plate 58 to assist in properly positioning the radius plate 60 relative to the main plate 58. The outer surface 72 of the radius plate 60 faces and overlies the inner surface 62 of the main plate 58, and an inner surface 74 of the radius plate 60 faces the interior of the housing 14 when the upper lid 16 is assembled to the housing 14. Each of the apertures 70 in the radius plate 60 are formed using a dimple manufacturing process that creates an integral, substantially frustoconical structure or dimple 76 that extends outwardly away from the inner surface 74 of the radius plate 60 and are concentrically and coaxially aligned with the apertures 70 in the radius plate 60. The dimple manufacturing process improves the structural integrity of the radius plate 60 and provides an improved structure for enhancing the welding process. The magnetic tubes 24 extend through the apertures 70 and the dimples 76 in the radius plate 60, through the apertures 66 in the main plate 58, and may abut or come close to the inner surface 79 of the cover plate 56. The magnetic tubes 24 are seam welded to the radius plate 60 between the dimples 76 and the magnetic tubes 24. The substantially frustoconical configuration of the dimples 76 provides an improved structure for seam welding as the spacing between the apertures 70 formed in the dimples 76 and the radius plate 60 are enlarged thereby allowing a larger weldment between the radius plate 60 and the magnetic tubes 24 while also allowing a higher degree of heat transfer of the welding material caused by the ambient air in the spacing between the dimples 76 and the radius plate 60 thereby providing a higher quality weld. Furthermore, by having the dimples 76 extend outwardly away from the inner surface 74 of the radius plate 60, the dimples 76 are positioned further along the longitudinal axis of the magnetic tubes 24 away from the main plate 58 and the radius plate 60 which provides further support of the magnetic tubes 24 on the upper lid 16 by providing an additional welding connection to the magnetic tubes 24 while also reducing the moment arm created by random forces applied to the magnetic tubes 24. The additional weld and support provided further along the longitudinal axis of the magnetic tubes 24 assist in further supporting the magnetic tubes 24 on the upper lid 16 thereby avoiding the magnetic tubes 24 from becoming dislodged, loosened, or separated from the upper lid 16 due to the application of random forces against the magnetic tubes 24.

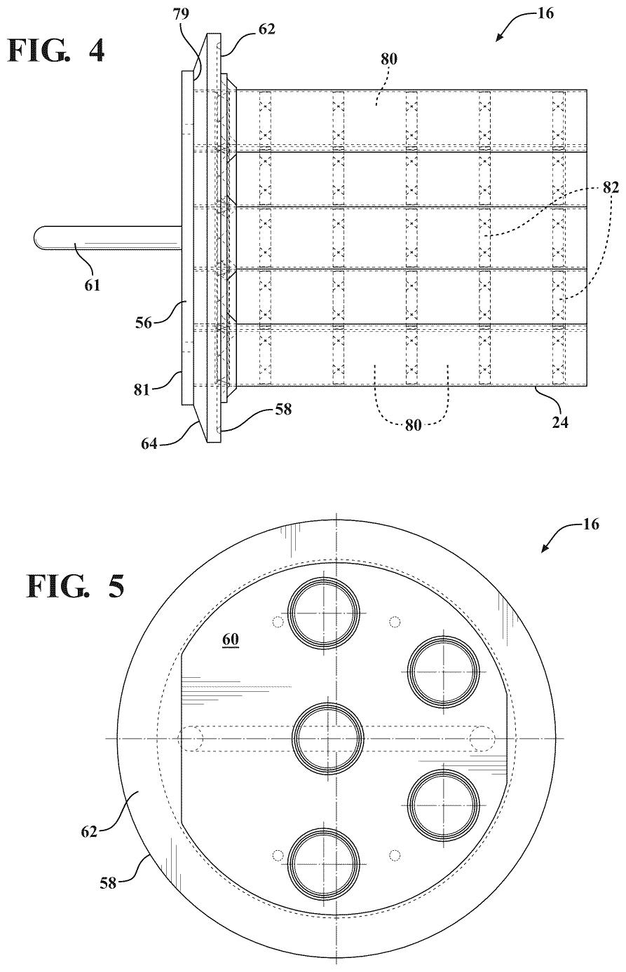

To attract metallic contaminants in the process fluids, the magnetic tubes 24 have substantially similar tubular or cylindrical configurations with a closed end 78 formed on the free end of the magnetic tubes 24 extending inward into the housing 14 and an open end (not shown) that extends into the main plate 58 and is covered by the cover plate 56. In a nonlimiting disclosure, the magnetic tubes 24 may also be different in size and configuration. The magnetic tubes 24 are fabricated from a light weight, high strength metallic material that will attract ferrous particles when magnetized, such as stainless steel. A plurality of rare earth cylindrical permanent magnets 80 are disposed within the magnetic tubes 24 wherein each of the cylindrical magnets 80 is separated by a nonmetallic spacer 82. The permanent magnets 80 are aligned in the magnetic tubes 24 such that similar poles of the permanent magnets 80 are adjacently aligned on opposite sides of the spacers 82, as shown in FIG. 4. For instance, the first magnet 80 at the closed end of the magnetic tubes 24 could have a north pole facing the bottom or closed end of the magnetic tube 24 which means the south pole of the magnetic would be at the opposite end of the magnet 80. A second magnet 80 would stack up adjacent the first magnet 80 with a spacer 82 therebetween. The second magnet 80 would be positioned such that its south pole would be adjacently aligned with the south pole of the first magnet 80. The matching of poles of the magnets 80 continues throughout the length of the magnetic tubes 24 thereby providing the proper magnetic flux for attracting the magnetic contaminants. In a nonlimiting disclosure, the magnetic tubes 24 may house four or five permanent magnets 80, although various numbers and strengths of magnets 80 may be utilized depending on the size of the magnets 80 or the size of the magnetic tubes 24. The magnets 80 in the magnetic tubes 24 provide a magnetic flux that attracts magnetic contaminants from the process fluids to the outer surfaces of the magnetic tubes 24.

The method of manufacturing the upper lid 16 of the magnetic separator 12 to provide a stronger and more reliable connection between the magnetic tubes 24 and the upper lid 16 of the magnetic separator 12 begins with the steps of providing a main plate 58 of the upper lid 16 with the apertures 66 extending therethrough. As described earlier, the main plate 58 has a substantially circular recess 84 formed on the inner surface 62 of the main plate 58 for receiving and positioning the outer surface 74 of the radius plate 60 such that the outer surface 74 of the radius plate 60 overlies the inner surface 62 of the main plate 58, and the plurality of apertures 66, 70 in the main plate 58 and the radius plate 60 are coaxially aligned. The outer circumference of the radius plate 60 is then seam welded to the main plate 58. The open end of the magnetic tubes 24 are inserted into the apertures 66, 70 provided in the radius plate 60 and the main plate 58 until the open end of the magnetic tubes 24 are aligned with the outer surface 64 of the main plate 58. The magnetic tubes 24 are seam welded to the main plate 58 and then seam welded to the dimples 76 on the radius plate 60. The plurality of substantially cylindrical magnets 80 and spacers 82 are alternately inserted into the open end of the magnetic tubes 24 until the magnets 80 and the spacers 82 fill the magnetic tubes 24. The magnetic circuit created by the magnets 80 in the magnetic tubes 24 is then tested to ensure that the proper magnetic flux is provided by the magnets 80 within the magnetic tubes 24. Once the proper magnetic circuitry is confirmed, the inside surface 79 of the cover plate 56 is placed over the outer surface 64 of the main plate 58 to cover the apertures 66 exposed on the outer surface 64 of the main plate 58 and provide an abutting or close to abutting surface for the magnets 80 and the spacers 82 in the magnetic tubes 24 and the open end of the magnetic tubes 24. The outer perimeter of the cover plate 56 is seam welded to the outer perimeter of the main plate 58. The handle 30 on the upper lid 16 may be seam welded to the upper lid 16 either before or after the cover plate 56 is seam welded to the main plate 58. The method and structure disclosed provides a more robust and reliable connection between the magnetic tubes 24 and the upper lid 16 of the magnetic separator 12 as the magnetic tubes 24 are welded to both the main plate 58 and the radius plate 60 and the quality and size of the weld between the dimples 76 and the magnetic tubes 24 are enhanced due to the structure of the dimples 76. Furthermore, the dimples 76 on the radius plate 60 provide added support by extending further outward from the main plate 58 and the radius plate 60 along the longitudinal axis of the magnetic tubes 24 thereby shortening any lever arm of the magnetic tubes 24 that may be created when lateral forces are applied to the magnetic tubes 24.

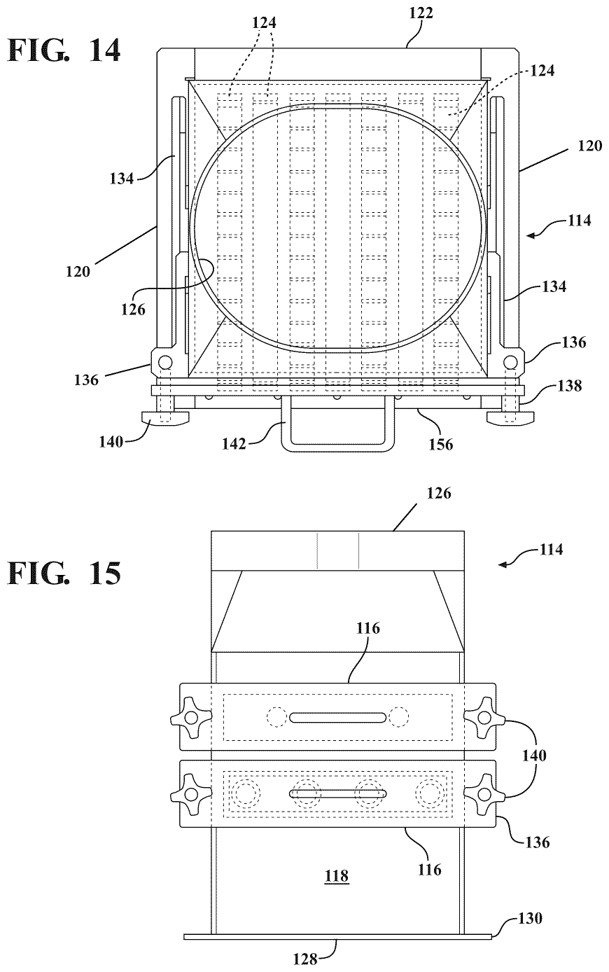

In another embodiment of the magnetic separator 12 as shown in FIGS. 14-18, the magnetic separator 12 may include a substantially rectangular, hollow housing 114 wherein the removable portion 15 of the magnetic separator 12 comprises at least one removable drawer 116 that slides into and out of corresponding openings provided in a front surface 118 of the housing 114 so as to enclose the housing 114 when the at least one drawer 116 is fully inserted into and connected to the housing 114. The at least one drawer 114 has at least one magnetic tube 124, hereby referred to as magnetic tubes 124, that are connected to an inside surface of the at least one drawer 116 and extend longitudinally and substantially horizontally outward from the inside surface of the at least one drawer 116 to the processing chamber in the inside of the housing 114. The housing 114 has an inlet 126 and an outlet 128 that are in communication with the interior of the housing 114, wherein the inlet 126 and the outlet 128 communicate process fluids through the processing chamber of the housing 114 of the magnetic separator 12 for separating magnetic contaminants from the process fluids. The process fluids are gravity fed through a grate formed by the magnetic tubes 124, and thus, this embodiment of the magnetic separator 12 is commonly referred to as a grate magnet bar drawer. This magnetic separator 12 may be used for process fluids related to powders and bulk solids. In a nonlimiting disclosure, the at least one drawer 114 may comprise two substantially similar drawers 114.

To allow the process fluids to pass by the magnetic tubes 124 and through the magnetic separator 12, the housing 114 of the magnetic separator 112 has a substantially rectangular, hollow configuration having the front surface 118, opposing side surfaces 120, and a back surface 122. The housing 114 further provides an open end at the top of the housing 114 which integrally forms the inlet 126 and an open end at the bottom of the housing 114 which integrally forms the outlet 128. A base 130 having a flange extending outwardly from the bottom of the housing 114 may be provided for mounting or connecting the housing 114 to a support structure (not shown). The top of the housing 114 is tapered inward to form a substantially elliptical opening forming the inlet 126. The inlet 26 allows the process fluids to enter the housing 114, wherein the process fluids drop through the housing 114 and exit through the outlet 128. The inlet 126 and the outlet 128 of the housing 14 may be connected to tubing, piping, ductwork, etc. (not shown) for transferring the process fluids to and from the magnetic separator 112. In a nonlimiting disclosure, the housing 114 may be fabricated from a light weight, high strength material such as steel or aluminum; however, other light weight, high strength materials may be used depending on the chemical composition or toxicity of the process fluids.

To allow for the removal and insertion of the drawers 116 from and into the housing 114, the housing 114 provides a pair of similar, substantially rectangular openings adjacently aligned and extending through the front surface 118 of the housing 114 to receive the pair of drawers 116. In operation, the drawers 116 may be fully inserted into the openings in the housing 114 such that the drawers 116 enclose the housing 114 in a sealed manner. Each of the drawers 116 has a cover plate 156 connected to a main plate 158 which is connected to a radius plate 160. The magnetic tubes 124 are connected to the main plate 158 and the radius plate 160, as will be described later. Each of the drawers 116 has a pair of opposing, substantially parallel rails 132 connected to and extending from opposing ends of the main plate 158. The rails 132 have a substantially rectangular, plate-like configuration with a tapered or chamfered free end. Each of the rails 132 are slidably received by substantially C-shaped brackets 134 connected to the opposing side surfaces 120 of the housing 114. The sliding of the rails 132 within the brackets 134 allows the drawers 116 to slide into a closed position, wherein the openings in the front surface 118 of the housing 114 are closed during operation of the magnetic separator 12, and an open position, wherein the drawers 116 may be pulled away from the housing 114 to allow the magnetic tubes 124 to be removed from within the housing 114 for cleaning of the magnetic contaminants from the magnetic tubes 124 during the nonoperation of the magnetic separator 12. A seal (not shown) may be provided between the main plate 158 and the front surface 118 of the housing 114 to provide for a sealed connection between the drawers 116 and the housing 114 in the closed position.

To lock or secure the drawers 116 in the closed position, a pair of similar brackets 136 may be connected to and extend from the opposing sides 120 of the housing 114 for each drawer 116. Each bracket 136 has a flange connected to and extending from the side surfaces 120 of the housing 114. A threaded stud 138 is connected to each of the mounting brackets 136 and extends outward from the front surface 118 of the housing 114. The threaded studs 138 may extend through a pair of U-shaped slots 146 provided in the ends of the cover plate 156 and the main plate 158 of each of the drawers 116. Threaded cap nuts 140 may be threaded onto each of the threaded studs 138 extending through opposite ends of the drawers 116 such that the cover plate 156 and the main plate 158 are positioned between the housing 114 and the threaded cap nuts 140. The threaded cap nuts 140 may be threaded onto the threaded studs 138 toward the housing 114 such that the drawers 116 are tightened against the housing 114 in the closed position for operation of the magnetic separator 112. To remove the drawers 116 and the magnetic tubes 124 from the housing 114, the threaded cap nuts 140 may be threaded off the threaded studs 138 so that the drawers 116 can be pulled away from the housing 114 for cleaning the magnetic contaminants from the magnetic tubes 124. A U-shaped handle 142 may be connected to the outer surface of the cover plate 156 and/or the main plate 158 of the drawers 116 to allow a user to slide the drawers 116 in and out of the housing 114 while also handling the drawers 116 when the drawers 116 are removed from the housing 114 for cleaning magnetic contaminants from the magnetic tubes 124.

To secure the magnetic tubes 124 to the drawers 116 of the magnetic separator 112, a similar construction is utilized as described in the previous embodiment, and therefore, any similar structures or descriptions from the previous embodiment with regard to the cover plate 156, the main plate 158, the radius plate 160, and the magnetics tubes 124 should be fully incorporated if not differentiated in the description of this embodiment. As previously described, each drawer 116 includes the cover plate 156, the main plate 158, and the radius plate 160. In a nonlimiting disclosure, the cover plate 156, the main plate 158, and the radius plate 160 may all be fabricated from a light weight, high strength metallic material, such as steel or aluminum. The main plate 158 has a substantially rectangular, plate-like configuration having an inner surface 162 that faces toward the interior of the housing 114 when the drawer 116 is inserted into the housing 114, and an outer surface 164, opposite the inner surface 162, that faces away from the housing 114. At least one apertures (not shown) extends through the main plate 158 from the inner surface 162 to the outer surface 164 of the main plate 158, and the number of apertures correspond to the number of magnetic tubes 124 provided in the drawer 116. In a nonlimiting disclosure, the drawers 116 may have a plurality of apertures, wherein one of the two drawers 116 may have three apertures in the main plate 158 corresponding to three magnetic tubes 124, and the second drawer 116 may have four apertures in the main plate 158 corresponding to four magnetic tubes 124. A different number and size of apertures and magnetic tubes 124 may be used based on the size and configuration of the drawers 116 and the magnetic separator 12. The three apertures in the main plate 158 of one of the drawers 116 are spaced evenly from the center of the main plate 158 along a longitudinal axis of the main plate 158, as shown in FIGS. 14 and 17. The four apertures 166 in the main plate 158 of the second drawer 116 are also evenly spaced at the same distance as the first drawer 116; however, in the second drawer 116, the four apertures 166 are off set from the center of the main plate 158 of the second drawer 116, as seen in FIG. 14. The positioning of the apertures 166 in the main plate 158 of the first and second drawers 116 will allow the magnetic tubes 124 to be strategically located so that the magnetic tubes 124 are laterally and vertically spaced between one another thereby ensuring that the process fluids will contact or come close to contacting at least one of the magnetic tubes 124 when passing through the housing 114 thereby attracting as many magnetic contaminants as possible to the magnetic tubes 124. For instance, as seen in FIG. 14, the magnetic tubes 124 from both drawers 116 are adjacently aligned such that there is little space for the process fluids to travel without contacting or coming close to contacting the magnetic tubes 124

To cover the apertures on the outer surface 164 of the main plate 158, the cover plate 156 has a substantially rectangular, plate-like configuration having the same or similar size as the outer surface 164 of the main plate 158. The cover plate 156 has an inner surface that overlies the outer surface 164 of the main plate 158 and may be connected to the main plate 158 by seam welding the circumference of the cover plate 156 to the circumference of the outer surface 164 of the main plate 158 or by using conventional fasteners (not shown) extending through apertures 144 provided in the main plate 158 and the cover plate 156. The cover plate 156 covers the apertures exposed on the outer surface 164 of the main plate 158 such that the magnetic tubes 124 extend through the apertures in the main plate 158 and may abut or come close to contacting the inner surface of the cover plate 156 thereby providing further support to the magnetic tubes 124. The magnetic tubes 124 are seam welded to the main plate 158 along the area of the main plate 158 that defines the apertures and receives the magnetic tubes 124.

To further support the attachment of the magnetic tubes 124 to the drawers 116, the radius plate 160 has a substantially rectangular, plate-like configuration having a width and length that is smaller than the main plate 158 and the cover plate 156. The radius plate 160 has at least one aperture 170, hereby referred to as apertures 170, that extends through the radius plate 160 and are equally spaced along a longitudinal axis of the radius plate 160 when a plurality of apertures 170 are present. The apertures 170 are coaxially aligned in position and number with the apertures provided in the main plate 158. In a nonlimiting disclosure, the number of apertures 170 in the radius plate 160 and the main plate 158 may be three in one drawer 116 and four in the second drawer 116, as previously described. The radius plate 160 has a substantially flat outer surface that faces and overlies the inner surface 162 of the main plate 158 and an inner surface 174 of the radius plate 160 that faces the interior of the housing 114 when the drawers 116 are assembled to the housing 114 in the closed position. Each of the apertures 170 in the radius plate 160 are formed using a dimple manufacturing process that creates an integral, substantially frustoconical structure or dimple 176 that extends outwardly away from the inner surface 174 of the radius plate 160 and are concentrically and coaxially aligned with the plurality of apertures 170 in the radius plate 160. As previously described, the dimple manufacturing process improves the structural integrity of the radius plate 160 and provides an improved structure for enhancing the welding process. The magnetic tubes 124 extend through the apertures 170 and the dimples 176 in the radius plate 160, through the apertures in the main plate 158, and may abut or come close to the inner surface of the cover plate 156. The magnetic tubes 124 are seam welded to the radius plate 160 between the dimples 176 and the magnetic tubes 124. The substantially frustoconical configuration of the dimples 176 provides an improved structure for seam welding as the spacing between the apertures 170 formed in the dimples 176 and the radius plate 160 are enlarged thereby allowing a larger weldment between the radius plate 160 and the magnetic tubes 124 while also allowing a higher heat transfer rate of the welding material caused by the ambient air in the spacing between the dimples 176 and the radius plate 160 thereby providing a higher quality weld. Furthermore, by having the dimples 176 extend outwardly away from the inner surface 174 of the radius plate 160, the dimples 176 are positioned further along the longitudinal axis of the magnetic tubes 124 away from the main plate 158 and the radius plate 160 which provides further support of the magnetic tubes 124 on the drawers 116 by providing an additional welding connection to the magnetic tubes 124 while also reducing the moment arm created by random forces applied to the magnetic tubes 124. The additional weld and support provided further along the longitudinal axis of the magnetic tubes 124 assist in further supporting the cantilevered magnetic tubes 124 on the drawers 116 thereby avoiding the magnetic tubes 124 from becoming dislodged, loosened, or separated from the drawers 116 due to the application of random forces against the magnetic tubes 124.

To attract metallic contaminants in the process fluids, the magnetic tubes 124 are assembled in a similar manner as described in the previous embodiment. That is, the magnetic tubes 124 have substantially similar or different tubular or cylindrical configurations with a closed end 178 formed on the free end of the magnetic tubes 124 extending inward into the housing 114 and an open end (not shown) that extends into the main plate 158 and is covered by the cover plate 156. The magnetic tubes 124 are fabricated from a light weight, high strength metallic material that will attract ferrous particles when magnetized, such as stainless steel. A plurality of rare earth cylindrical permanent magnets 180 are disposed within the magnetic tubes 124 wherein each of the cylindrical magnets 180 is separated by a nonmetallic spacer 182. The permanent magnets 80 are aligned in the magnetic tubes 124 such that similar poles of the permanent magnets 80 are adjacently aligned on opposite sides of the spacers 82, as similarly shown in FIG. 4. For instance, the first magnet 80 at the closed end of the magnetic tubes 124 could have a north pole facing the bottom or closed end of the magnetic tube 124 which means the south pole of the magnet 80 would be at the opposite end of the magnet 80. A second magnet 80 would stack up adjacent the first magnet 80 with a spacer 82 therebetween. The second magnet 80 would be positioned such that its south pole would be adjacently aligned with the south pole of the first magnet 80. The matching of poles of the magnets 80 continues throughout the length of the magnetic tubes 124 thereby providing the proper magnetic flux for attracting the magnetic contaminants. In a nonlimiting disclosure, the magnetic tubes 124 may house four or five permanent magnets 80, although various numbers of magnets 80 may be utilized depending on the size of the magnets 80 or the size of the magnetic tubes 124. The magnets 80 in the magnetic tubes 124 provide a magnetic flux that attracts magnetic contaminants from the process fluids to the outer surfaces of the magnetic tubes 124.

The method of manufacturing the drawers 116 of the magnetic separator 12 to provide a stronger and more reliable connection between the magnetic tubes 124 and the drawers 116 of the magnetic separator 12 begins with the steps of providing a main plate 158 of the drawers 116 with the extending therethrough. As described earlier, the outer surface 174 of the radius plate 160 overlies the inner surface 162 of the main plate 158, and the apertures 170 in the main plate 158 and the radius plate 160 are coaxially aligned. The outer circumference of the radius plate 160 is then seam welded to the main plate 158. The open end of the magnetic tubes 124 are inserted into the apertures 170 provided in the radius plate 160 and the main plate 158 until the open end of the magnetic tubes 124 are aligned with the outer surface 164 of the main plate 158. The magnetic tubes 124 are then seam welded to the main plate 158 and then seam welded to the dimples 176 on the radius plate 160. The substantially cylindrical magnets 80 and spacers 82 are alternately inserted into the open end of the magnetic tubes 124 until the magnets 80 and the spacers 82 fill the magnetic tubes 124. The magnetic circuit created by the magnets 80 in the magnetic tubes 124 is then tested to ensure that the proper magnetic flux is provided by the magnets 80 within the magnetic tubes 124. Once the proper magnetic circuitry is confirmed, the inside surface of the cover plate 156 is placed over the outer surface 164 of the main plate 158 to cover the apertures exposed on the outer surface 164 of the main plate 158 and provide an abutting or close to abutting surface for the magnets 80 and the spacers 82 in the magnetic tubes 124 and the open end of the magnetic tubes 124. The outer perimeter of the cover plate 156 is seam welded to the outer perimeter of the main plate 158, or the cover plate 156 may be connected to the main plate 158 through conventional fasteners extending through apertures in the main plate 158 and the cover plate 156. The handle 142 on the drawers 116 may be seam welded to the drawers 116 either before or after the cover plate 156 is connected to the main plate 158. The method and structure disclosed provides a more robust and reliable connection between the magnetic tubes 124 and the drawers 116 of the magnetic separator 12 as the magnetic tubes 124 are welded to both the main plate 158 and the radius plate 160 and the quality and size of the weld between the dimples 176 and the magnetic tubes 124 is enhanced due to the structure of the dimples 176. Furthermore, the dimples 176 on the radius plate 160 provide added support by extending further outward from the main plate 158 and the radius plate 160 along the longitudinal axis of the cantilevered magnetic tubes 124 thereby shortening any lever arm that may be created when lateral forces are applied to the magnetic tubes 124.

While the disclosure has been made in connection with what is presently considered to be the most practical and preferred embodiment, it should be understood that the disclosure is intended to cover various modifications and equivalent arrangements described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

What is claimed is:

1. A magnetic separator for removing magnetic contaminants from process fluids, comprising:
a housing having an inlet and an outlet adaptable for communicating the process fluids through the housing;
a removable structure removably connected to and enclosing the housing, and the removable structure having at least one of aperture;
at least one dimple formed about the circumference of each of the at least one aperture in the removable structure;
at least one magnetic tubes each having one end received by one of the at least one aperture and a second opposite end disposed within the interior of the housing; and
the at least one dimple connected to the at least one magnetic tube to further support the connection between the at least one magnetic tube and the removable structure.

2. The magnetic separator stated in claim 1, further comprising:
the at least one magnetic tube seam welded to the at least one dimple on the removable structure.

3. The magnetic separator stated in claim 1, the removable structure further comprising:
a main plate having the at least one aperture formed therein;
a radius plate connected to the main plate and having the at least one aperture extending therethrough wherein the at least one aperture in the radius plate is coaxially aligned with the at least one aperture in the main plate; and
the at least one dimple formed about the circumference of the at least one aperture in the radius plate.

4. The magnetic separator stated in claim 3, further comprising:
the radius plate having an inner surface facing the interior of the housing; and
the at least one dimple formed on the inner surface of the radius plate and having a frustoconical configuration extending away from the inner surface of the radius plate.

5. A magnetic separator for removing magnetic contaminants from process fluids, comprising:
a housing having an inlet and an outlet adaptable for communicating the process fluids through the housing;
a removable structure removably connected to and enclosing the housing, and the removable structure having a main plate and a radius plate;
the main plate having a plurality of apertures formed therein for receiving a plurality of magnetic tubes wherein one of the plurality of magnetic tubes extends into each of the plurality of apertures and wherein the plurality of magnetic tubes are connected to the main plate;
the radius plate connected to the main plate and having a plurality of apertures extending therethrough and coaxially aligned with the plurality of apertures in the main plate for receiving one of the plurality of magnetic tubes in each of the plurality of apertures in the radius plate;
a plurality of dimples formed about the circumference of each of the plurality of apertures in the radius plate; and
the plurality of magnetic tubes welded to the plurality of dimples to connect the plurality of magnetic tubes to the radius plate to further support the connection between the plurality of magnetic tubes and the removable structure, wherein the plurality of magnetic tubes are disposed within the housing for adaptably attracting the magnetic contaminants from the process fluids.

6. The magnetic separator stated in claim 5, further comprising:
the plurality of dimples each having a frustoconical configuration extending away from the radius plate toward the interior of the housing and along a longitudinal axis of the plurality of magnetic tubes.

7. The magnetic separator stated in claim 5, wherein the removable structure further comprises an upper lid of the housing.

8. The magnetic separator stated in claim 5, wherein the removable portion further comprises at least one drawer slidably connected to the housing.

9. The magnetic separator stated in claim 5, further comprising:
the main plate having the plurality of apertures extending through the main plate; and
a cover plate connected to the main plate on the opposite side of the main plate from the radius plate and covering the plurality of apertures on one side of the main plate wherein one end of the plurality of magnetic tubes is adjacent the cover plate.

10. The magnetic separator stated in claim 5, further comprising:
the plurality of apertures in the main plate, the plurality of apertures in the radius plate, and the plurality of magnetic tubes spaced substantially equidistant from one another.

11. The magnetic separator stated in claim 5, further comprising:
the plurality of magnetic tubes seam welded to the plurality of dimples of the radius plate and seam welded to the main plate.

12. The magnetic separator stated in claim 5, further comprising:
a plurality of permanent magnets and spacers disposed within the plurality of magnetic tubes.

13. The magnetic separator stated in claim 5, further comprising:
the plurality of magnetic tubes each having an open end connected to the main plate and a closed end disposed within the interior of the housing.

14. A method of fabricating a magnetic separator for separating magnetic contaminants from process fluids, comprising:
providing a housing having an inlet and an outlet adaptable for communicating process fluids through the housing;
providing a removable structure having a main plate and a radius plate wherein the removable structure may be removably connected to the housing for enclosing the housing;
forming at least one aperture in the main plate;
forming at least one aperture and at least one of dimple in the radius plate wherein the at least one dimple is formed about a circumference of the at least one aperture in the radius plate;
connecting the main plate to the radius plate such that the at least one aperture in the main plate are coaxially aligned with the at least one aperture in the radius plate;
inserting at least one magnetic tube into the at least one of aperture in the main plate and through the at least one aperture in the radius plate;
connecting the at least one magnetic tube to the main plate; and
connecting the at least one magnetic tube to the at least one dimple on the radius plate.

15. The method as stated in claim 14, wherein the step of forming the at least one aperture and the at least one dimple in the radius plate further comprises the steps of:
providing the at least one dimple with a frustoconical configuration that extends around the circumference of the at least one aperture in the radius plate and extends away from the radius plate along a longitudinal axis of the at least one magnetic tube.

16. The method as stated in claim 14, wherein the steps of providing a removable structure further comprise the steps of:
extending the at least one aperture through the main plate; and
connecting a cover plate to the main plate on the opposite side of the main plate as the radius plate for covering the at least one aperture on one side of the main plate and adjacently aligning the cover plate with one end of the at least one magnetic tube.

17. The method as stated in claim 14, wherein the steps of providing a removable structure further comprise the steps of:
providing at least one drawer that slidably engages the housing.

18. The method as stated in claim 14, wherein the steps of providing a removable structure further comprise the steps:
providing an upper lid of the housing.

19. The method as stated in claim 14, wherein the steps further comprise:
seam welding the at least one magnetic tube to the main plate and to the at least one dimple on the radius plate.

20. The method as stated in claim 14, further comprising the steps of:
inserting a plurality of permanent magnets and spacers into the at least one magnetic tube.
